(19) United States
(12) Patent Application Publication
(10) Pub. No.: US 2006/0209392 A1
(43) Pub. Date: Sep. 21, 2006

(54) Multi-stage optical amplifier optimized with respect to noise, gain and bandwidth

(76) Inventors: Renato Caponi, Torino (IT); Annachiara Pagano, Torino (IT); Marcello Potenza, Torino (IT); Bruno Sordo, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/568,080

(22) PCT Filed: Aug. 11, 2003
(86) PCT No.: PCT/EP03/08910

§ 371 Date: Feb. 13, 2006

(51) Int. Cl. H01S 3/00

(52) U.S. Cl. 359/337.4

(57) ABSTRACT

A multi-stage optical amplifier for a fiber-optic transmission system, in particular, an amplifier having a multi-stage configuration that allows an optimization of its performance with respect to noise, gain and bandwidth. The multi-stage amplifier has a first amplifying stage including a rare-earth doped optical active fiber; a second amplifying stage connected to the first amplifying stage, the second amplifying stage including a tellurite-based active fiber doped with a rare earth element; and a third amplifying stage connected with the second amplifying stage, the third amplifying stage including a silica-based fiber.

### TECHNICAL FIELD

The present invention relates to a multi-stage optical amplifier for a fiber-optic transmission system, in particular to an amplifier having a multi-stage configuration that allows an optimization of its performance with respect to noise, gain and bandwidth.

### TECHNOLOGICAL BACKGROUND

In telecommunication fiber-optic transmission systems, such as wavelength division multiplexing (WDM), a plurality of optical signals of different wavelengths is transmitted through a single optical fiber. In these systems, amplification is often needed according to the distance over which optical signals should be transmitted to and it can be performed by means of optical amplifiers.

In order to increase the capacity of WDM systems, i.e., the number of available signal channels, optical amplifiers with broad amplification bandwidth and high output power are necessary. In addition, high gain, so that longer distances can be travelled by the signals (thus reducing the number of amplifying and regeneration sites), and low noise, so that a better bit-error rate at the receiver is available, are desired. However, wide bandwidth, low noise and high gain are usually difficult to achieve within a single optical amplifier.

In WDM transmission systems employing both the C- and L-bands as transmission bands, erbium-doped fiber amplifiers (EDFAs) with a parallel C- and L-band configuration can be used. However, by using silica-based EDFA, there is a dip in the amplification band of the parallel configuration at around 1565 nm, i.e. approximately between the C- and L-bands, because of band-coupling, making the amplification less efficient.

Erbium-doped tellurite-based fiber amplifiers (EDTFAs) offer the potential of a wide bandwidth in the 1525+1630 nm band, which includes approximately the C- and L-bands, thus increasing the potential bandwidth of standard silica-based erbium (Er)-doped amplifiers. An EDTFA can in principle amplify signals ranged over the C- and L-bands continuously.

One technical problem arising in connection with the usage of the EDTFA is that its noise figure (NF) in the C-band wavelength region with 1480 nm pumping is higher than that of an Er-doped silica fiber (EDSF) amplifier pumped at 980 nm. Generally speaking, an Er-doped silica fiber pumped at 980 nm has a noise figure close to the quantum limit of 3 dB, while the same fiber pumped at 1480 nm has a minimum noise figure of more than 4 dB. In addition to these theoretical noise levels, insertion losses should also be considered. Due to the lower insertion losses of an EDSF with respect to an EDTF, an EDSFA has a lower overall NF than an EDTFA, considering both fibers pumped at the same wavelength. In “980 nm band pumped E³⁺-doped tellurite—, vol. 38, No. 23, p. 1419-1420, an EDTFA with a 980 nm band pumping is described. Optimization of pump wavelength and of the length of the fiber leads to a noise figure of less than 4.5 dB.

In “A Low-noise and Broad-Band Erbium-Doped Tellurite Fiber Amplifier With a Seamless Amplification Band in the C- and L-bands”, published in IEEE Photonics Technology Letters vol. 14, No. 8, p. 1073-1075, a three-stage optical amplifier is disclosed, in which all stages comprise a tellurite-based amplifying fiber. The three-stage configuration uses a 980-nm-band pumped EDTFA as the first-stage amplifier.

Applicants have observed that efficiency of the 980 nm band pumping of an EDTFA is strongly dependent on the fiber physical characteristics, which influence inter alia the lifetime of the emission levels in the 980 nm pump band. Consequently, 980 nm band pumping of an EDTFA results often inefficient for many of the newly developed or commercially available tellurite-based optical fibers. As mentioned in the above-mentioned articles, to obtain an efficient pumping EDTFAs are to be pumped at 976 nm, and not at 980 nm, therefore pumping sources specially configured for this application are required, instead of the commonly available ones. Splicing of a non-silica fiber, such as a tellurite fiber, to a silica fiber, from which regular transmission fibers are made, is generally cumbersome if relatively low splice losses are sought. Silica glasses and non-silica glasses typically exhibit highly different thermal characteristics, indeed the gap between the respective softening temperatures can exceed 1000° C., so that they cannot be jointed by conventional arc fusion splicing techniques. This means that it is rather complex and time consuming to realize low loss joints between transmission fibers and non-silica fibers, such as tellurite fibers.

U.S. Pat. No. 6,356,387 describes a splicing structure to splice a non silica-based fiber with a silica-based fiber in order to achieve low-loss and low-reflection. One of the embodiments disclosed in the patent describes a two stage optical amplifier including a first aluminum-added Er-doped silica-based optical fiber and a second Er-doped tellurite-based optical fiber.

In “Gain-flattened Tellurite-Based EDFA with a Flat Amplification Bandwidth of 76 nm”, published in IEEE Photonics Technology Letters vol. 10, No. 9, p. 1244-1246, an optical amplifier comprising two tellurite-based Er-doped fibers connected in series is disclosed. Gain flatness was improved by using a gain equalizer connected to the output port of the optical amplifier.

Applicants have noted that in order to realize a fiber amplifier including a tellurite-based fiber with a good noise figure, pumping in the 1480 nm absorption band in a first stage of the amplifier is less desirable. The use of a 1480 nm pumping allows however to achieve high gain and high output powers, both in silica and tellurite fibers.

Recently, wide-band tellurite-based fiber Raman amplifier to amplify optical signals from the S-(1460-1530 nm) to L-bands simultaneously have been investigated. U.S. Patent application No. 2002/0167717 is relative to a Raman amplifier using tellurite glass as a gain medium. In one of the disclosed embodiments for the Raman amplifier, a tellurite fiber and a silica fiber are connected in series.

### SUMMARY OF THE INVENTION

The present invention relates to a wide gain bandwidth multi-stage optical fiber amplifier, in which at least an amplifying stage comprises a rare-earth doped tellurite-based optical fiber.

In the context of the present invention, with tellurite-based optical fibers we mean optical fibers which comprise substantially tellurite glass as host material, i.e., TeO₂, although more complex glass compositions that include in a smaller percentage other oxides such as ZnO, Bi₂O₃ or Na₂O, are not excluded. Co-dopants, also non-optically active (i.e., non amplifying), such as Ge, Si or Al, can be intended to be comprised in the matrix of tellurite fibers.

With silica-based fibers, we refer to optical fibers comprising substantially silica glass, i.e., SiO₂.

Co-dopants, also non-optically active (i.e., non amplifying), such as Ge, B or Al, can be intended to be comprised in the matrix of silica-based fibers.

It is known that the noise figure of a two-stage amplifier is dominated by the noise figure of the first stage of the amplifier. Applicants have observed that the use of a first amplifying stage of a multi-stage optical amplifier comprising a rare-earth doped silica-based optical fiber reduces the noise figure, especially in the C-band wavelength region. Preferably, the first stage of the amplifier is pumped in the 980 nm band. More preferably, the rare-earth doped silica-based optical fiber is an Er-doped silica-based fiber (EDSF). Even more preferably, the rare-earth doped silica-based optical fiber is pumped in a forward direction to the transmission signal to improve the noise figure over the whole C-band, without a corresponding degradation in the L-band. Applicants have observed a noise figure of less than 5 dB in the 1545-1570 nm wavelength region for a two-stage configuration in which the first stage comprises a EDSF pumped at about 980 nm and the second stage comprises a Er-doped tellurite-based fiber (EDTF) bi-directionally pumped at 1480 nm.

In the L-band, the achievable gain per unit length is typically lower than in the C-band, especially in silica hosts. Tellurite fiber hosts generally provide a larger gain in the L-band. Applicants have noticed that in EDTFAs the gain in the L-band remains however significantly lower than that of the C-band. They have surprisingly found that the addition of an amplification stage comprising a silica-based fiber, which is located at the output of an amplification stage comprising an EDTF, leads to a significant increase of the output power across the C-band and also in the L-band.

Specifically, a considerable increase of the overall optical gain across the C+L band has been observed in an amplifier having a three-stage configuration, in which the second stage comprises a EDTF and the third amplification stage comprises a silica-based optical fiber. It was furthermore observed that the presence of a third stage comprising a silica-based optical fiber does not appreciably influence the noise figure of the combination of the first and the second amplification stage.

In particular, the invention relates to a multi-stage optical amplifier to amplify a transmission signal including a signal wavelength (λ₆) comprising
a first amplifying stage including a rare-earth doped optical active fiber;
a second amplifying stage connected to said first amplifying stage, said second amplifying stage including a tellurite-based active fiber doped with a rare earth element; and
a third amplifying stage connected with said second amplifying stage, said third amplifying stage including a silica-based fiber.

According to a preferred embodiment of the invention, the third amplification stage includes a rare earth doped silica-based optical fiber. Preferably, the rare-earth doped silica-based optical fiber is an EDSF which is pumped bi-directionally, more preferably with a co-propagating pump radiation in the 1480 nm band and a counter-propagating one in the 1480 nm band.

According to another preferred embodiment of the invention, the third amplification stage includes a Raman-active silica-based optical fiber. In this context, an optical fiber used as Raman amplifying medium for signals will be referred to as a Raman-active optical fiber. More preferably, the pump radiation of the pump source for amplifying the Raman-active optical fiber propagates in a backward (i.e., counter-propagating) direction to the transmission signal radiation. The pump radiation preferably has a wavelength comprised in the range 1460+1500 nm.

In order to achieve a flattened gain in the C- and L-bands, it is preferable to include a gain equalizing filter (GEF) at the output of the amplification stage comprising the EDTF. The effect of the GEF is to reduce the maximum gain excursion between the C- and the L-band by cutting part of the gain in the C-band. It is to be understood that the increase of optical gain in the L-band due to the amplification stage comprising a silica-based fiber at the output of the amplification stage comprising an EDTF will improve the overall performance of the amplifier, also with gain equalization.

These objects and others, which will become clear from the following description, are achieved by the invention with a multi-stage optical amplifier obtained in accordance with the appended claims.

### BRIEF DESCRIPTION OF THE DRAWINGS

Further features and advantages of a multistage optical amplifier according to the invention will become more clearly apparent from the following detailed description thereof, given with reference to the accompanying drawings, where:

FIG. 1a schematically depicts a multi-stage optical amplifier according to the present invention.

FIG. 1b shows a more detailed block diagram of the amplifier of FIG. 1a according to a first embodiment of the present invention.

FIG. 1c shows a more detailed block diagram of the amplifier of FIG. 1a according to a second embodiment of the present invention.

FIG. 2 is a graph showing the gain of the second amplifying stage of the multi-stage optical amplifier of FIG. 1a as a function of the input signal wavelength for different input signal powers ranging from −18 to 2 dBm.

FIG. 3 is a graph showing the noise figure of the second amplifying stage of the multi-stage optical amplifier of FIG. 1a as a function of the input signal wavelength for different input signal powers ranging from −18 to 2 dBm.

FIG. 4 is a graph showing the signal output power of the second amplifying stage of the multi-stage optical amplifier of FIG. 1a as a function of the input signal wavelength for different input signal powers ranging from −18 to 2 dBm.

FIG. 5 is a graph showing the gain spectrum of a two-stage amplifier including the first and second amplifying stages of FIG. 1a as a function of the input signal wavelength for an input signal power of −3 dBm.

FIG. 6 is a graph showing the noise figure of the first and second amplifying stages of FIG. 1a as a function of the input signal wavelength for an input signal power of −3 dBm.

FIG. 7 is a graph showing the signal output power of the first and second amplifying stages of FIG. 1a as a function of the input signal wavelength for an input signal power of −3 dBm.

FIG. 8 is a graph showing the gain of the three-stage optical amplifier of FIG. 1b as a function of the input signal wavelength for different input signal powers ranging from −18 to 2 dBm.

FIG. 9 is a graph showing the noise figure of the three-stage optical amplifier of FIG. 1b as a function of the input signal wavelength for different input signal powers ranging from −18 to 2 dBm.

FIG. 10 is a graph showing the signal output power of the multi-stage optical amplifier of FIG. 1b as a function of the input signal wavelength for different input signal powers ranging from −18 to 2 dBm.

### PREFERRED EMBODIMENTS OF THE INVENTION

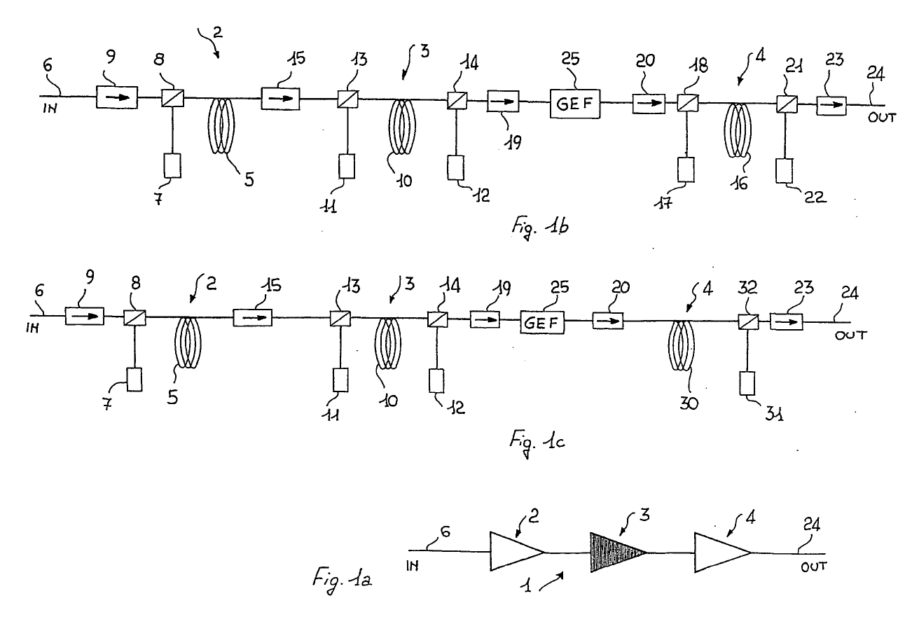

With reference to FIG. 1a, 1 indicates a three-stage optical amplifier according to an embodiment of the present invention. In particular, an amplifying stage includes a length of amplifying optical fiber associated to at least a pumping source. The optical amplifier 1 comprises a first 2, a second 3 and a third 4 amplification stage connected in series in said order. The three-stage optical amplifier 1 receives at an input in an optical signal 6 to be amplified and outputs at an output OUT the amplified output optical signal 24. The input optical signal 6 includes at least a signal wavelength λ_{S}. Preferably, the optical signal carries a number of optical channels λ_{S1}, . . . , λ_{Sn}, comprised between about 1530 nm and 1625 nm, which corresponds approximately to the C- and L-bands. For example, in case of 50 GHz standard ITU-T DWDM channel spacing, the wavelength of the first channel will be 1528.38 nm (corresponding to 196.15 THz in frequency), while the wavelength of the last channel will be 1622.25 nm (i.e., 184.80 THz), the total number of channels being 228.

With reference to FIG. 1b, the first amplification stage 2 of the optical amplifier 1 comprises a rare-earth-doped amplifying fiber 5 and a first pump source 7 for pumping the amplifying fiber 5. Pump radiation is optically coupled to the amplifying fiber 5 by means of an optical coupler 8, for example a WDM coupler, that combines the signal band to be amplified with the pump radiation and couples the superimposed signal to one end of the amplifying fiber. In the present embodiment, pump radiation propagates in a forward (co-propagating) direction to the transmission signal at a pump wavelength λₚ₁. Preferably, pump wavelength λₚ₁ is of about 980 nm, which allows a low-noise output signal from the first stage 2. The maximum power of the pump radiation is preferably comprised in the range 100+200 mW. However, if low energy loss or good gain stabilization are of higher concern than noise, a pumping wavelength of 1480 nm could be used. In this case, a counter-propagating pump scheme could also be considered, provided that a suitable pump power is available.

In the present embodiment, the amplifying fiber 5 is preferably an EDSF. Alternatively, the active fiber 5 can be an erbium-doped tellurite glass fiber, which is the most widespread non-silica host matrix. In case of choosing a tellurite fiber as active fiber, care should be taken in its selection in order to obtain a first amplifying stage having a very low noise figure.

The amplifier 1 also comprises a second amplifying stage 3 connected in series to the first stage 2. This second stage 3 comprises a rare-earth tellurite-based optical fiber 10, having bi-directional pumping with second and third pump sources 11, 12 supplying pump radiation at respective appropriate wavelengths λₚ₂ and λₚ₃, the pump radiation of the second pump source 11 propagating in a forward direction and the pump radiation of the third pump source 12 propagating in a backward direction to the signal (in this case the input signal corresponds to the output signal of the first amplifying stage 2). Couplers 13, 14 are used to optically couple the EDTF to the second pump source 11 and to the third pump source 12, respectively.

Preferably, the rare-earth tellurite-based optical fiber 10 is an Er-doped tellurite-based fiber (EDTF), having for example an erbium concentration of about 5000 ppm within a glass matrix of TeO₂, including in a smaller percentage ZnO and Na₂O. The bi-directional pumping shown in FIG. 1b is the preferred pumping configuration because it gives the best compromise between complexity of configuration and performances. Alternatively, also a forward pumping configuration or a backward pumping configuration are intended to be covered by the present invention.

The pumping wavelengths λₚ₂ and λₚ₃ of pump sources 11 and 12 are preferably selected approximately equal to 1480 nm. Typical powers of the pump radiation are preferably in the range 100+160 mW.

Optical isolators can be inserted between each stage of the amplifier to prevent the backward propagating amplified spontaneous emission (ASE) from depleting pumps in the preceding stages. FIG. 1b shows inter-stage isolators 15 and 19. Isolators 9 and 23 can also be inserted at the input 6 and at the output 24 of the amplifier, respectively, to avoid interaction through reflected radiation between the amplifier 1 and an optical line to which the amplifier is commonly in use.

The third amplification stage 4, connected in series to the second stage 3, comprises an amplifying silica-based fiber 16 which is bi-directionally pumped by, fourth and fifth pump sources 17 and 22 at pumping wavelengths λₚ₄ and λₚ₅, respectively, through couplers 18 and 21. Preferably, a gain equalizing filter (GEF) 25 is interposed between the second amplification stage 3 and the third amplification stage 4, in order to achieve a flattened gain in the amplification bands of interest, such as the C and L-bands. For example, a long-period fiber grating can be used. In this case, an additional optical isolator 20 can be optionally added, so that the GEF 25 is sandwiched between two isolators 19 and 20.

In the embodiment illustrated in FIG. 1b, the third amplification stage 4 is a rare-earth doped silica-based fiber, preferably an Er-doped silica-based fiber. Preferably, pump wavelengths λₚ₄ and λₚ₅ for the Er-doped silica-based are of about 1480 nm and 1480 nm, respectively. However, also other pumping wavelengths or configurations are possible, such as a co-propagating pumping at about 980 nm and a counter-propagating pumping at about 1480 nm. Although a bi-directional pumping scheme has been described for the amplification stage 2, backward pumping (counter-propagating configuration) or forward pumping are also allowed. FIG. 1c illustrates a further embodiment of the present invention. The same reference numerals are given to elements of the optical amplifier corresponding to those shown in FIG. 1b and their detailed explanation is omitted. In FIG. 1c, the third amplification stage 4 is a Raman amplifier including a Raman-active silica-based fiber 30. In a preferred configuration, the Raman-active silica-based fiber 30 is a dispersion compensating fiber (DCF), i.e., a fiber that is apt to decrease or nullify the dispersion of light within optical fiber systems by counter-balancing the dispersion. For example, the DCF is a negative dispersion fiber with a relatively small effective area (e.g. 40 μm²), which provides a good Raman efficiency. A backward pumping configuration is preferred, with pump radiation emitted from pump source 31 having pumping wavelength λₚ₆ of for example 1480 nm. Pump radiation originating from pump source 31 is coupled to the signal radiation by means of optical coupler 32.

Although examples of Er-doped amplifying fibers have been made in the described preferred embodiments, other rare earth elements can be included in the silica or in the tellurite glass composition as optically active elements. Examples of doping rare-earth elements are thulium, praseodymium, neodymium or ytterbium, the rare earth element being selected in dependence of the desired amplification band and bandwidth. A change in the doping element often implies a change in the band which can be amplified by the amplifier 1. The input signal therefore should carry optical channels having wavelengths in the amplifiable band (for example in the O-band, from 1290 to 1320 nm, or in the S-band, from 1490 to 1520 nm). It is understood that pump wavelengths of the pump sources in the stages of the amplifier should be then accordingly selected by taking into account the noise figure of the first stage and the overall gain of the amplifier.

Preferably, in the assembly of the amplifier 1 a “modular approach” is applied. Given a certain non conventional optical amplifier having specified characteristics, like a multi-stage amplifier in which the second amplifying stage includes a EDTF, the first and third stage coupled at the two end of it are chosen so that the resulting characteristics of the assembled amplifier are tailored for the needed application. In each module, which corresponds to a single amplifying stage, the active fiber is connected with an optical fiber connector (OFC), for example an FC/PC (i.e. a physical-contact fiber connector), which is connected to other modules, thus to another OFC, or to a transmission optical fiber. Preferably, each module is provided with optical isolators on the input and on the output of the amplifying region.

The modular approach is based on the use of already available modules (=amplifying stages) which have fixed length and fiber composition on their assembly so as to optimize the overall characteristics.

In addition to the three above described stages, others stages can be incorporated in the amplifier of the present invention, preferably located between the stages above described. For example, a Dispersion Compensating Module can be added dedicated to the compensation of dispersion impairments over long transmission links, or an Optical Add/Drop Multiplexer to provide flexibility and dynamical provisioning of optical paths in networks, such as ring or mesh networks.

Optical characteristics and amplification performances of the amplifier of the invention have been measured by the Applicant.

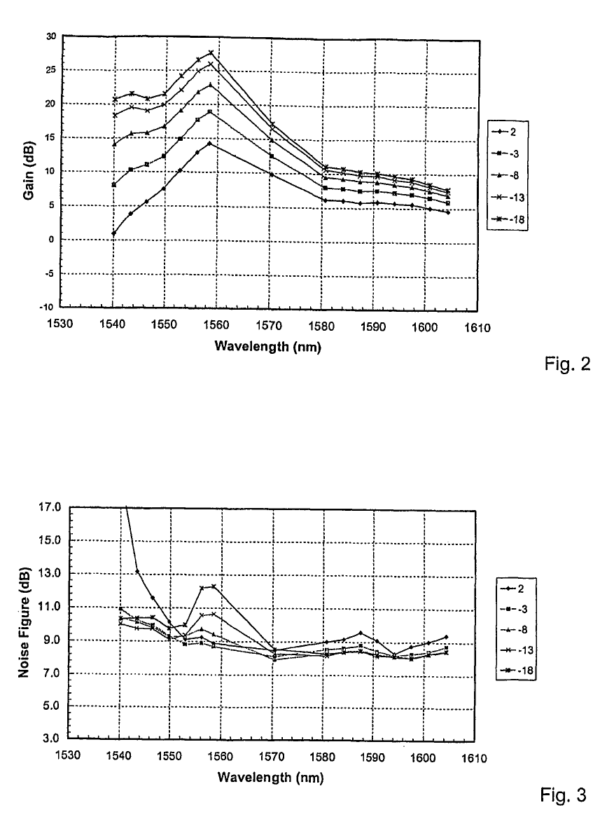

In FIGS. 2-4, exemplary optical characteristics of the second amplifying stage 2 are illustrated. FIGS. 2 to 4 refer to a second stage 2 including a EDTF used in a sixteen channel configuration, i.e., used to amplify sixteen different optical channels, which was bi-directionally pumped at 1480 nm. The active fiber was connected to the external silica pig-tails (not shown) through a simple mechanical alignment. FIGS. 2, 3 and 4 show respectively the channel gain, noise figure and signal output power obtained for each optical channel. In the legend of each figure, the total input power level (dBm units) at which a specific curve has been measured is shown. It is clear from FIG. 3 that the noise of the second amplification stage is relatively high, due, among others, to the high coupling losses of the non-silica active fiber with silica pig-tails. Indeed no special stringent requirements have been applied to the joints made. Noise is also due to optical pumping at 1480 nm.

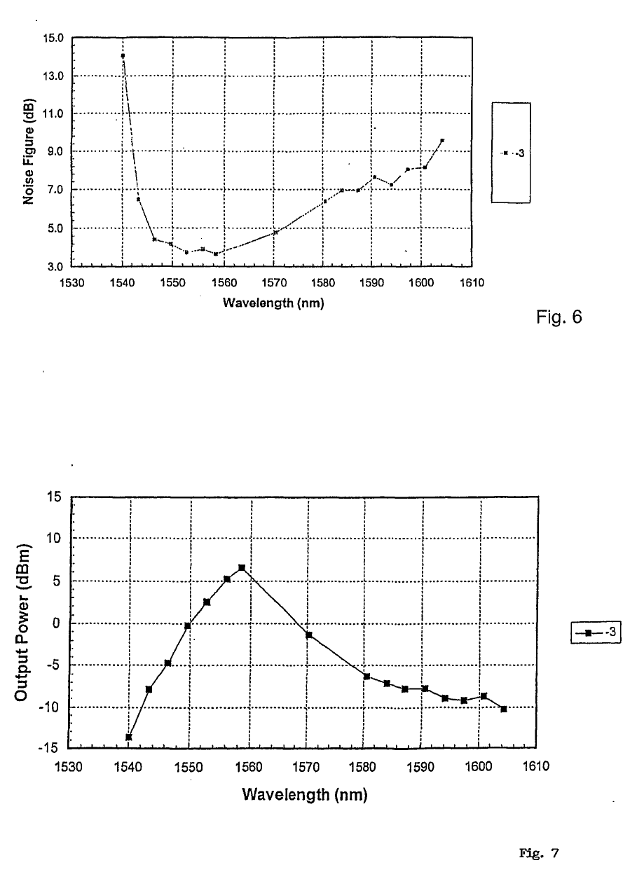

FIGS. 5 to 7 are relative to characteristics of the output signal provided by a two-stage configuration that includes the first and second amplifying stage 2,3 serially connected, as shown in FIGS. 1b and 1c. The first stage 2 is a commercially available EDSF pumped at 980 nm, wavelength at which the noise is close to its quantum limit of 3 dB. FIG. 6 shows clearly that the addition of this EDFA, which acts as a preamplifier, substantially reduces the overall noise of the system composed by the EDFA and the EDTFA. Therefore, even if no particular care has been taken in splicing the silica and non-silica fibers and a rather “simple” splice technique has been used, a very low noise can be achieved. It is not difficult to obtain an EDFA whose noise is nearly equal to the quantum limit also because its connection to the transmission fiber, which is also silica based, is made through conventional arc fusion techniques.

Finally, the amplifier configurations of FIGS. 1a and 1b has been investigated. A third stage comprising an EDSF, in particular a conventional booster EDFA, has been coupled in series at the output of the second stage.

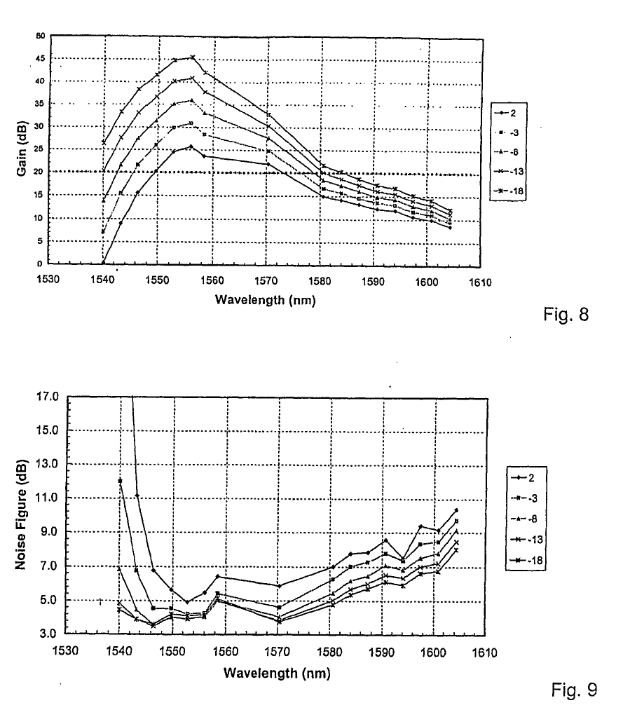

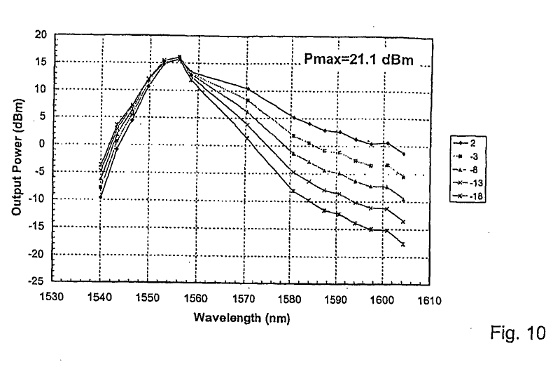

FIG. 8 shows that the peak gain has increased and that a 20 dB gain level has been reached for signals up to 1580 nm wavelength. FIG. 9 shows that the noise figure is lower than 7 dB over the bandwidth 1540-1605 nm and that the minimum values obtained over the C-band (3.5 dB at 1546 nm) are close to the quantum limit. This leads to the conclusion that the presence of the third stage in addition to the first plus second stage configuration above investigated does not increase the noise, which remains substantially unaffected (and low).

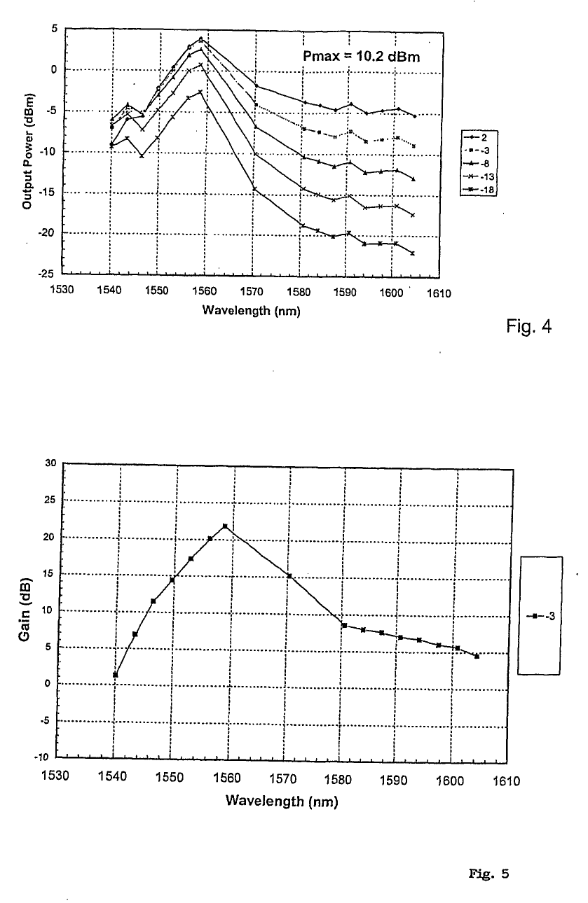

The effect of this third stage on the output power of the amplifier is quite surprising: the power emitted by the three-stage amplifier within the L-band has an appreciable increase with respect to the power emitted in the same band by the EDTFA (second stage). From the comparison of the measurements plotted in FIGS. 4 and 10, FIG. 4 shows that the EDTFA alone emits roughly 10 dBm over the entire C+L spectrum, whereas FIG. 10 shows that in the three-stages configuration 13 dBm are emitted over the L-band alone.

To obtain a flat gain, gain equalization between the C- and the L-bands is desirable. The GEF partially cuts the emission on the C band—which underwent a higher amplification than the L band signals. It was observed that, assuming a flattening of the gain spectrum, an emission of 21 dBm over the entire bandwidth C+L is obtained.

It is known that the amplification of a signal obtained using an EDTFA is intrinsically wavelength dependent, so that higher amplification of C-band wavelength signals is achieved, while a lower amplification is obtained when the input signals have a wavelength in the L-band. The addition of the third stage, which is substantially a booster, further increases the power emitted in the C band, while increasing also the power emitted in the L band.

Moreover, the use of EDSF booster as the final stage in connection with a suitably designed GEF gives higher flat gain and output power levels than with the EDTFA alone.

The increase of the gain, especially in the L-band, is also obtained in case a Raman amplifier replaces the booster EDFA at the output of the stage with the EDTFA. With reference to the corresponding measurements regarding the EDTFA alone (FIG. 4), the gain of a two-stage amplifier, which include the Raman amplifier, is improved of 5+6 dB on average. The power emitted over the L-band, in particular, increases from −9.4 dBm to −3.4 dBm in small signal conditions and from 5.5 dBm to 10.5 dBm in saturation. Over the whole spectrum the average gain is increased by 3 dB.

The improvement of the signal gain due to the Raman amplifier is expected also in the three-stage configuration. A preferred embodiment of the invention relates to a three-stage optical amplifier, in which the first stage includes an EDSF, the second stage includes an EDTF and the third stage includes a silica-based Raman-active optical fiber.

A first and principal advantage is that the multi-stage amplifier according to the invention provides a high power output, especially over the L-band, with respect to a single EDTFA or to a two-stage amplifier in which a silica-based EDFA pre-amplifies an EDTFA.

Another advantage is the simple and relatively low-cost assembly of the multi-stage amplifier, due to the “modular” approach, in which already available amplifiers as modules are used.

Not last, the multi-stage amplifier of the present invention achieves very low noise.

1-28. (canceled)

29. A multi-stage optical amplifier to amplify a transmission signal including a signal wavelength comprising
a first amplifying stage including a rare-earth doped optical active fiber;
a second amplifying stage connected to said first amplifying stage, said second amplifying stage comprising a tellurite-based active fiber doped with a rare earth element; and
a third amplifying stage connected with said second amplifying stage, said third amplifying stage including a silica-based fiber.

30. The multi-stage optical amplifier according to claim 29, wherein said first, second and third amplifying stages are connected in series.

31. The multi-stage optical amplifier according to claim 29, wherein said signal wavelength is 1530 to 1625 nm.

32. The multi-stage optical amplifier according to claim 29, wherein an input signal carries a given number of optical channels having wavelengths of about 1530 nm and 1625 nm.

33. The multi-stage optical amplifier according to claim 29, wherein said rare earth doped active fiber of said first amplifying stage is an erbium doped active fiber.

34. The multi-stage optical amplifier according to claim 29, wherein said rare-earth doped active fiber of said first amplifying stage is a silica-based active fiber.

35. The multi-stage optical amplifier according to claim 29, wherein said first amplifying stage comprises a first pumping source to supply a first pumping radiation to said rare-earth doped active fiber at a first pump wavelength.

36. The multi-stage optical amplifier according to claim 35, wherein said first pumping radiation and said transmission signal are co-propagating within said rare-earth doped active fiber.

37. The multi-stage optical amplifier according to claim 35, wherein said first pump wavelength is substantially equal to 980 nm.

38. The multi-stage optical amplifier according to claim 29, wherein an optical isolator is located between said first and said second amplifying stages.

39. The multi-stage optical amplifier according to claim 29, wherein an optical isolator is located at an input of said first amplifying stage.

40. The multi-stage optical amplifier according to claim 29, wherein said tellurite-based active fiber doped with a rare-earth element of said second amplifying stage is a tellurite-based erbium doped active fiber.

41. The multi-stage optical amplifier according to claim 29, wherein said second amplifying stage comprises a second and a third pumping source for supplying second and third pumping radiation at second and third pump wavelengths, respectively, to said tellurite-based active fiber doped with a rare-earth element.

42. The multi-stage optical amplifier according to claim 41, wherein said second pumping radiation and an optical signal outputted by said first amplifying stage are co-propagating, and said third pumping radiation and said optical signal outputted by said first amplifying stage are counter-propagating within said tellurite-based active fiber doped with a rare-earth element.

43. The multi-stage optical amplifier according to claim 41, wherein said second and third pump wavelengths are both substantially equal to 1480 nm.

44. The multi-stage optical amplifier according to claim 29, wherein said silica-based fiber of said third amplifying stage is a rare-earth doped active fiber.

45. The multi-stage optical amplifier according to claim 44, wherein said silica-based fiber of said third amplifying stage is an erbium-doped active fiber.

46. The multi-stage optical amplifier according to claim 29, wherein said third amplifying stage comprises a fourth and a fifth pumping source for supplying a fourth and fifth pumping radiation at a fourth and fifth wavelength, respectively, to said silica-based fiber.

47. The multi-stage optical amplifier according to claim 46, wherein said fourth pumping radiation and an optical signal outputted by said second amplifying stage are co-propagating, and said fifth pumping radiation and said optical signal outputted by said second amplifying stage are counter-propagating, within said silica-based fiber.

48. The multi-stage optical amplifier according to claim 46, wherein said fourth and fifth pump wavelength are both substantially equal to 1480 nm.

49. The multi-stage optical amplifier according to claim 29, wherein said silica-based fiber is a Raman-active fiber.

50. The multi-stage optical amplifier according to claim 49, wherein said silica-based fiber is a dispersion compensating fiber.

51. The multi-stage optical amplifier according to claim 49, wherein said third amplifying stage comprises a pumping source for supplying a pumping radiation at a pump wavelength to said Raman-active fiber.

52. The multi-stage optical amplifier according to claim 51, wherein said pumping radiation and an optical signal outputted by said second amplifying stage are counter-propagating, within said Raman-active fiber.

53. The multi-stage optical amplifier according to claim 51, wherein said pump wavelength is substantially from 1460 to 1500 nm.

54. The multi-stage optical amplifier according to claims 29, wherein a gain equalizer is interposed between said second and third amplifying stages.

55. The multi-stage optical amplifier according to claim 29, wherein an optical isolator is interposed between said second and third amplifying stages.

56. The multi-stage optical amplifier according to claim 29, wherein an optical isolator is inserted at the output of said third amplifying stage.
